(19) United States
(12) Patent Application Publication
(10) Pub. No.: US 2015/0367494 A1
(43) Pub. Date: Dec. 24, 2015

(54) Counterweight Mechanism and Power Tool

(71) Applicant: Bosch Power Tools (China) Co. Ltd., Hangzhou (CN)

(72) Inventor: Jia Wang, Hangzhou (CN)

(21) Appl. No.: 14/746,944

(22) Filed: Jun. 23, 2015

(30) Foreign Application Priority Data
Jun. 23, 2014 (CN) 201410284736.6

(51) Int. Cl. B25F 5/00; F16H 25/14; F16F 7/104; F16H 19/02

(52) U.S. Cl. CPC B25F 5/006; F16H 19/02; F16H 25/14; F16F 7/104

(57) ABSTRACT

A counterweight mechanism for a linearly reciprocating mechanism includes a counterweight configured to balance an inertial force of the reciprocating mechanism, a driving element configured to drive the counterweight to linearly reciprocate, a guiding element configured to guide the counterweight to linearly reciprocate, and an auxiliary driving mechanism configured to auxiliarily drive the counterweight to linearly reciprocate. The auxiliary drive mechanism is configured to exert a force on the counterweight in a direction of the linear reciprocation of the counterweight, which direction alternatingly changes, to promote the linear reciprocation. This configuration enables the reduction or avoidance of vibration and noise of the counterweight mechanism and prolongs a service lifetime thereof. The counterweight mechanism can be included in a power tool.

This application claims priority under 35 U.S.C. § 119 to patent application no. CN 2014 10 284 736.6, filed on Jun. 23, 2014 in China, the disclosure of which is incorporated herein by reference in its entirety.

The present disclosure relates to a counterweight mechanism and especially to a counterweight mechanism for a linearly reciprocating mechanism and a power tool comprising the counterweight mechanism.

### BACKGROUND

In a machine having a linearly reciprocating mechanism, a counterweight mechanism which moves in a direction opposite to the linearly reciprocating mechanism is usually provided to balance a linear reciprocation of the linearly reciprocating mechanism, thereby reducing a vibration of the machine during the linear reciprocation of the linearly reciprocating mechanism.

FIG. 1 is a simplified schematic view showing a prior linearly reciprocating mechanism and a counterweight of a machine such as a jigsaw, and FIG. 2 is a side view of FIG. 1. As shown in FIGS. 1 and 2, the linearly reciprocating mechanism of the jigsaw comprises a gear 3 mounted onto a rotation shaft 1. An eccentric pin 5 is disposed on one side of the gear 3, and a free end of the eccentric pin 5 is connected with a working part 9 having a saw blade 7. A counterweight mechanism of the jigsaw comprises an eccentric cam 11 disposed on the other side of the gear 3 and a counterweight 13 mounted on the eccentric cam 11, and the eccentric cam 1 I is movably located in an elongated hole 15 in the counterweight 13. The elongated hole 15 is defined by two generally parallel surfaces and two curved surfaces. Only the two generally parallel surfaces are active surfaces that are in contact with the eccentric cam 11. When the working part 9 brings the saw blade 7 to move upwards along a direction indicated by an arrow RI as the gear 3 is driven by a driving gear (not shown), the counterweight 13 moves downwards along a direction indicated by an arrow R2; and vice versa. The motion of the counterweight 13 mainly results from a contact force exerted on the counterweight 13 by the eccentric cam 11 disposed on the gear 3. If the contact force is too big, the eccentric cam 11 itself and the two generally parallel surfaces of the elongated hole 15 in the counterweight 13 will be worn, which consequently increases the vibration and the noise during the operation of the jigsaw and shortens the service lifetime of the eccentric cam and counterweight.

Thus, there is a need to make improvement on the exiting counterweight mechanism for the linearly reciprocating mechanism.

### SUMMARY

An object of the present disclosure is to overcome at least one of the defects in the prior art and to provide an improved counterweight mechanism for the linearly reciprocating mechanism. The counterweight mechanism can reduce the wear on the eccentric cam and the counterweight while the whole machine is light in weight and has a high efficiency, thereby reducing or avoiding the vibration and noise of the eccentric cam and the counterweight and prolonging their service lifetime.

To this end, according to one aspect of the present disclosure, a counterweight mechanism for linearly reciprocating mechanism is provided, A counterweight mechanism for a linearly reciprocating mechanism comprising:
a counterweight for balancing an inertial force of the linearly reciprocating mechanism;
a driving element for driving the counterweight to reciprocate linearly; and
a guiding element for guiding the counterweight to reciprocate linearly;
wherein the counterweight mechanism further comprises an auxiliary driving means for driving auxiliarily the counterweight to reciprocate linearly, the auxiliary driving means exerts on the counterweight in a direction of the linear reciprocation of the counterweight a force which promotes the linear reciprocation and whose direction changes alternately.

Preferably, the auxiliary driving means comprises at least one spring which is disposed between the counterweight and a frame of the linearly reciprocating mechanism along the direction of the linear reciprocation of the counterweight such that the spring and the counterweight form a spring-mass system.

Preferably, the spring is configured such that a component force of a spring force generated by the spring in the direction of the linear reciprocation of the counterweight is greater than that in a direction perpendicular to the direction of the linear reciprocation of the counterweight.

Preferably, the spring is configured such that an action line of a spring force generated by the spring passes through a center of mass of the counterweight.

Preferably, the spring is selected such that its spring constant k is given by an equation below:

k=m×ω²

where m is a mass of the counterweight, and ω is an angular frequency of the linear reciprocation of the counterweight.

Preferably, an inherent angular frequency of the spring-mass system is within a range of an angular frequency of the linear reciprocation of the counterweight.

Preferably, a spring force generated by the spring is zero when the counterweight is at a mid-position of the linear reciprocation.

Preferably, the counterweight is configured to reciprocate linearly along a direction opposite to a direction of the motion of the linearly reciprocating mechanism.

Preferably, the counterweight is configured to reciprocate linearly along a direction perpendicular to a direction of the motion of the linearly reciprocating mechanism.

Preferably, the at least one spring comprises one spring, one end of the spring is connected to the counterweight, and the other end of the spring is fixed at the frame.

Preferably, the at least one spring comprises two compression springs, one of the two compression springs is disposed between one end of the counterweight and the frame, and the other one of the two compression springs is disposed between the other end of the counterweight and the frame.

Preferably, the two compression springs are connected with the frame only at one end while they are not connected to the counterweight at the other end.

Preferably, the driving element comprises an eccentric cam which is mounted onto a rotation shaft rotatably supported on a frame and rotates with the rotation shaft.

Preferably, the guiding element comprises a guiding portion fixed at the frame.

Preferably, an elongated hole defined by two parallel surfaces and two curved surfaces is formed in the counterweight, the eccentric cam is mounted in the elongated hole such that an outer edge of the eccentric cam only contacts the two parallel surfaces of the elongated hole.

Preferably, the driving element comprises a driving rod which can reciprocate linearly, and the counterweight is mounted on the driving rod.

Preferably, the guiding element comprises a guiding rod passing through a through hole in the counterweight.

Preferably, the linearly reciprocating mechanism is a linearly reciprocating mechanism of a power tool.

Preferably, the power tool is a reciprocating saw or an electric hammer. According to another aspect of the present disclosure, a power tool comprising the linearly reciprocating mechanism is provided. The linearly reciprocating mechanism further comprises a counterweight mechanism as described above.

Preferably, the power tool is a reciprocating saw or an electric hammer.

As there is provided at least one spring between the counterweight and the frame along the direction of the linear reciprocation of the counterweight, the counterweight mechanism for the linearly reciprocating mechanism according to the present disclosure may avoid or significantly reduce the friction force and thus the abrasion on the counterweight and components (e.g., driving elements or guiding elements) contacting with the counterweight, thereby reducing or avoiding the vibration and the noise of the counterweight as well as prolonging the service lifetime of the machine.

### BRIEF DESCRIPTION OF THE DRAWINGS

In the drawings:

FIG. 1 is a simplified schematic view showing a linearly reciprocating mechanism and a counterweight of a prior jigsaw;

FIG. 2 is a side view of FIG. 1;

FIG. 3 is a schematic view showing a counterweight mechanism for a linearly reciprocating mechanism according to a first preferred embodiment of the present disclosure; and

FIG. 4 is a schematic view showing a counterweight mechanism for a linearly reciprocating mechanism according to a second preferred embodiment of the present disclosure.

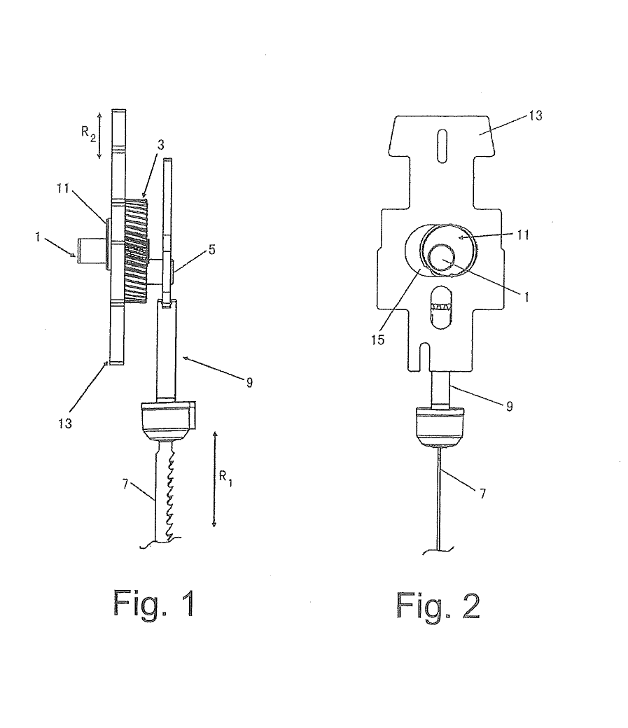

### DETAILED DESCRIPTION

Hereinafter, preferred embodiments of the present disclosure will be described in detail in connection with the examples. It should be understood by a skilled in the art that these exemplary embodiments are not constructed to be any limiting to the present disclosure.

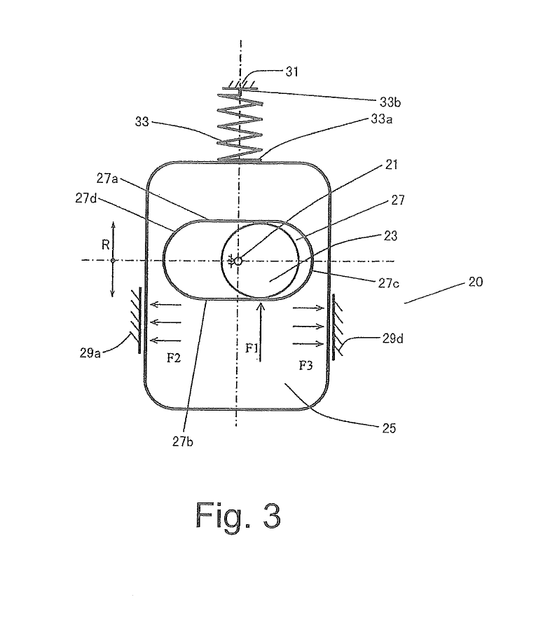

FIG. 3 is a schematic view showing a counterweight mechanism for a linearly reciprocating mechanism according to the first preferred embodiment of the present disclosure. For simplicity, a linearly reciprocating mechanism for a reciprocating power tool such as a jigsaw is not shown in FIG. 3. As shown in FIG. 3, a counterweight mechanism 20 for a linearly reciprocating mechanism according to the first preferred embodiment of the present disclosure comprises a rotation shaft 21 rotatably supported on a frame, an eccentric cam 23 being capable of rotating with the rotation shaft 21, and a counterweight 25 mounted on the eccentric cam 23. An elongated hole 27 defined by two generally parallel surfaces 27a, 27b and two curved surfaces 27c, 27d is formed in the counterweight 25. The eccentric cam 23 is mounted in the elongated hole 27 of the counterweight 25 such that the outer edge of the eccentric cam 23 only contacts with the two generally parallel surfaces 27a, 27b of the elongated hole 27, i.e., only the two generally parallel surfaces 27a, 27b of the elongated hole 27 form the active contact surfaces. Further, the counterweight mechanism also comprises the guiding portions 29a, 29d fixed on the frame to guide the counterweight 25 to reciprocate.

As known, when the eccentric cam 23 is driven to rotate, it contacts with one of the two generally parallel surfaces 27a, 27b of the elongated hole 27 in the counterweight 25, causing the counterweight 25 to move up and down along a direction indicated by an arrow R in the FIG. 3, thereby balancing an inertial force of the linearly reciprocating mechanism (not shown) moving in opposite directions. During the up and down movement of the counterweight 25, the counterweight 25 exerts on the eccentric cam 23 and the guiding portions 29a, 29d the forces FI, F2 and F3 respectively. These forces result in a respective reacting force acting on the counterweight 25. A resultant force formed by these reacting forces drives the counterweight 25 to reciprocate. The forces F2 and F3 always are negligible because they are very small compared to the force F1. Thus, in practice, it is mainly the force F1 exerted on the eccentric cam 23 by the counterweight 25 and its reacting force that result in a friction force and thus an abrasion between the eccentric cam 23 and the counterweight 25 during the up and down movement of the counterweight 25.

According to the present disclosure, the counterweight mechanism 20 further comprises a spring 33 which is disposed between the counterweight 25 and the frame 31 alone the direction R of the linear reciprocation of the counterweight 25. In a preferred embodiment, one end 33a of the spring 33 is connected to the counterweight 25, and the other end 33b of the spring 33 is fixed at the frame 31. In this way, the spring 33 and the counterweight 25 form a spring-mass system which can do a simple harmonic motion. When the counterweight 25 is at its equilibrium position, the spring 33 is free; when the counterweight 25 is at a half cycle above the equilibrium position, the spring 33 is compressed; and when the counterweight 25 is at a half cycle below the equilibrium position, the spring 33 is stretched. Thus, during the linear reciprocation of the counterweight 25 driven by the eccentric cam 23, the spring 33 exerts on the counterweight 25 in the reciprocating direction of the counterweight 25 a force whose direction changes alternately, thereby assisting to drive the counterweight 25.

Theoretically, the closer to the angular frequency of the linear reciprocation of the counterweight the resonant frequency of the spring-mass system is, the smaller the force F1 exerted on the eccentric cam 23 by the counterweight 25 and its associated reacting force, i.e., the contact force between the eccentric cam 23 and the counterweight 25 will be. Thus, preferably, the spring 33 is selected such that its spring constant k is given by an equation below:

k=m×ω²

where m is the mass of the counterweight 25, and ω is the angular speed of the linear reciprocation of the counterweight 25. Accordingly, the resonant frequency of the spring-mass system is approximately equal to the angular frequency of the linear reciprocation of the counterweight 25. In practice, however, it's also possible for the resonant frequency of the spring-mass system to be within a range of the angular frequency of the linear reciprocation of the counterweight.

Furthermore, in order to avoid generating an additional torque in the spring-mass system during the simple harmonic motion, an action line of a spring force generated by the spring 33 is configured to be parallel to the direction of the linear reciprocation of the counterweight 25, more preferably, to pass through a center of mass of the counterweight 25. It should be understood that, when a plurality of springs are used, the action line of the spring force herein refers to the action line of the resultant force of the spring forces generated by the plurality of springs. With the gravity being ignored, the spring force generated by the spring 33 will be approximate to zero when the counterweight 25 comes to a mid-position of the linear reciprocation.

According to a structure of a specific machine comprising the linearly reciprocating mechanism, the counterweight mechanism may comprise one or more springs. The one or more springs may be disposed at one or two ends of the counterweight 25 along the direction R of the linear reciprocation of the counterweight 25. For example, each of the two ends of the counterweight 25 may be provided with one spring 33 along the direction R of the linear reciprocation of the counterweight 25. In this case, the spring 33 is a compression spring, and the ends of the springs 33 are not necessary to connect to the counterweight 25.

Because the spring 33 and the counterweight 25 form the spring-mass system doing the simple harmonic motion when the spring 33 is provided, the force generated by the spring 33 becomes a main force that drives the counterweight 25 to reciprocate linearly. The force generated by the spring 33 will not result in the friction force and thus the abrasion of the counterweight as there is no relative movement between the counterweight 25 and the spring 33. On the other hand, the force FI exerted on the eccentric cam 23 by the counterweight 25 and its associated reacting force could be significantly reduced as they only serve as a supplement to the energy loss of the spring-mass system. Accordingly, the friction force resulting from the contact force and thus the abrasion of the eccentric cam 23 and counterweight 25 can be avoided or significantly reduced, such that the vibration and noise of the eccentric cam and the counterweight can be reduced or avoided and their service lifetime can be prolonged.

In order to verify the effect of the present disclosure, on basis of GST90 jigsaw of the BOSCH, two compression springs are disposed at the top of the counterweight along the direction of the linear reciprocation of the counterweight. The upper end of the two compression springs is fixed to the frame (housing) of the jigsaw and the lower end of the two compression springs is not fixed to the counterweight. This means that the springs are active only in the upper half cycle of the counterweight. According to the present disclosure, it could be predicted that the upper surface of the two generally parallel surfaces of the elongated hole of the counterweight contacting with the eccentric cam would be worn, while the lower surface of the two generally parallel surfaces contacting with the eccentric cam would not or hardly be worn. After operation for a long time, it was proved that the upper surface of the two generally parallel surfaces of the elongated hole was worn while the lower surface of the two generally parallel surfaces of the elongated hole was not worn even with the tooling textures remained.

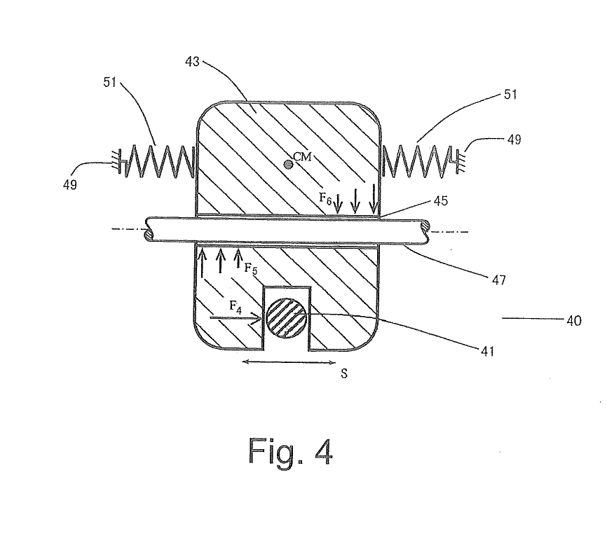

FIG. 4 is a schematic view showing the counterweight mechanism for the linearly reciprocating mechanism according to a second preferred embodiment of the present disclosure. For simplicity, the linearly reciprocating mechanism for a reciprocating power tool such as a saber saw or an electric hammer is not shown in FIG. 4. As shown in FIG. 4, the counterweight mechanism 40 for the linearly reciprocating mechanism according to the second preferred embodiment of the present disclosure comprises a driving rod 41 which forms as a part of, for example, a wobble bearing and can reciprocate linearly along a direction indicated by an arrow S, a counterweight 43 which is mounted on the driving rod 41 and can reciprocate linearly together with the driving rod 41 along the direction indicated by the arrow S, and a guiding rod 47 passing through a through hole 45 in the counterweight 43 along a direction parallel to the direction indicated by the arrow S to guide the linear reciprocation of the counterweight 43.

As well known, in order to balance the linear reciprocation of the linearly reciprocating mechanism, the center of mass CM of the counterweight 43 is offset to a motion path of the driving rod 41. For example, during the rightward movement of the counterweight 43 along the direction indicated by the arrow S, the driving rod 41 exerts on the counterweight 43 a force F4. As the center of mass eM of the counterweight 43 is offset to the motion path of the driving rod 41, the counterweight 43 has a leftward inertial force. The leftward inertial force results in a torque which tends to cause the counterweight 43 to rotate anticlockwise; vice versa. Accordingly, as the counterweight 43 is subjected to the torque which tends to cause the counterweight 43 to rotate anticlockwise due to driving force from the driving rod 41, the portions of the counterweight 43 contacting with the guiding rod 47 are subjected to the forces F5 and F6 as shown in FIG. 4. The forces F4, F5 and F6 exert on the driving rod 41 and the guiding rod 47 the respective reacting force respectively. The force F4 and its associated reacting force can hardly result in any abrasion on the driving rod 41 and the counterweight 43 because there is hardly any relative movement between the driving rod 41 and the counterweight 43. However, there exists a relative movement between the counterweight 43 and the guiding rod 47 due to the torque tending to cause the counterweight 43 to rotate, thus the forces F5 and F6 and their associated reacting force will result in a serious abrasion on the counterweight 43 and the guiding rod 47.

According to this embodiment, the counterweight mechanism 40 of the present disclosure also comprises a spring 51 disposed between the counterweight 43 and the frame 49 along a direction S of the linear reciprocation of the counterweight 43. In this preferred embodiment, it is shown that each of the two ends of the counterweight 43 is provided with one spring 51 along the direction S of the linear reciprocation of the counterweight 43. In this case, the spring 51 is a compression spring, and the ends of the spring 51 could be not connected to the counterweight 43. Of course, the ends of the spring 51 could be connected to the counterweight 43 if necessary. It should be understood that, however, it is possible to provide only one spring 51 between the counterweight 43 and the frame 49 along the direction S of the linear reciprocation of the counterweight 43, as shown in the figure of the first preferred embodiment. One end of the spring 51 is connected to the counterweight 43, and the other end of the spring is fixed at the frame 49. Of course, it is possible to provide a plurality springs 51. Therefore, when the counterweight 43 is driven by the driving rod 41 to reciprocate linearly, the spring (s) 51 exert (s) on the counterweight 43 in the reciprocating direction of the counterweight 43 a force whose direction changes alternately, thereby assisting to drive the counterweight 43.

The spring 51 is selected such that its spring constant k is given by an equation below:

k=m×ω²

where m is the mass of the counterweight 43, and ω is the angular frequency of the linear reciprocation of the counterweight 43. Accordingly, the inherent angular frequency of the spring-mass system is approximately equal to the angular frequency of the linear reciprocation of the counterweight 43. In practice, however, it is possible for the inherent angular frequency of the spring-mass system to be within a range of the angular frequency of the linear reciprocation of the counterweight.

In order to avoid generating an additional torque in the spring-mass system during the simple harmonic motion, an action line of a spring force generated by the spring 51 is configured to be parallel to the direction of the linear reciprocation of the counterweight 43, more preferably, to pass through a center of mass of the counterweight 43. It should be understood that, when a plurality of springs are used, the action line of the spring force herein refers to the action line of the resultant force of the spring forces generated by the plurality of springs. With the gravity being ignored, the spring force generated by the spring 51 will be approximate to zero when the counterweight 43 comes to a mid-position of the linear reciprocation.

It should be understood that an electromagnetic device, a hydraulic device or a pneumatic device could be provided as an alternative to the spring in the foregoing preferred embodiments to achieve a similar function as the spring.

The present disclosure has been described in detail in connection with the particular embodiments. Obviously, it should be understood that embodiments described above and shown in the figures are illustrative rather than limiting. For example, in the foregoing preferred embodiments, the counterweight is configured to reciprocate linearly along a direction opposite to the direction of the linear reciprocation of the linearly reciprocating mechanism, however, it should be understood that in the case that the inertial force in the direction of the linear reciprocation of the linearly reciprocating mechanism is translated into an inertial force in a direction perpendicular to the direction of the linear reciprocation by the eccentric cam, the counterweight can also be configured to reciprocate linearly in the direction perpendicular to the direction of the linear reciprocation of the linearly reciprocating mechanism. Further, it should be contemplated by the skilled in the art that the direction of the linear reciprocation of the counterweight can also be configured to be oblique to the moving direction of the linearly reciprocating mechanism at an angle. In this case, a force exerted on the counterweight by an auxiliary driving means refers to a component force in the direction of the linear reciprocation of the counterweight, and preferably the auxiliary driving means is configured such that its component force in the direction of the linear reciprocation of the counterweight is greater than its component force in the direction perpendicular to the direction of the linear reciprocation of the counterweight. Various modifications and changes within the scope of the present disclosure can be made by the skilled in the art without departing the spirits of the present disclosure.

What is claimed is:

1. A counterweight mechanism for a linearly reciprocating mechanism, comprising:
a counterweight configured to balance an inertial force of the linearly reciprocating mechanism;
a driving element configured to drive the counterweight to linearly reciprocate;
a guiding element configured to guide the linear reciprocation of the counterweight; and
an auxiliary driving mechanism configured to auxiliarily drive the counterweight to linearly reciprocate, the auxiliary drive being further configured to exert a force on the counterweight in an alternatingly changing direction of the linear reciprocation of the counterweight to promote the linear reciprocation of the counterweight.

2. The counterweight mechanism according to claim 1, further comprising:
a frame;
wherein the auxiliary driving mechanism includes at least one spring positioned between the counterweight and the frame along a direction of the linear reciprocation of the counterweight such that the spring and the counterweight form a spring-mass system.

3. The counterweight mechanism according to claim 2, wherein the at least one spring is configured such that a component force of a spring force generated by the at least one spring in the direction of the linear reciprocation of the counterweight is greater than another component force of the spring force in a direction perpendicular to the direction of the linear reciprocation of the counterweight.

4. The counterweight mechanism according to claim 2, wherein the at least one spring is configured such that an action line of a spring force generated by the at least one spring passes through a center of mass of the counterweight.

5. The counterweight mechanism according to claim 2, wherein the at least one spring has a spring constant k given by an equation:
k=m×ω²
where m is a mass of the counterweight, and ω is an angular frequency of the linear reciprocation of the counterweight.

6. The counterweight mechanism according to claim 2, wherein the spring-mass system has an inherent angular frequency that is within a range of an angular frequency of the linear reciprocation of the counterweight.

7. The counterweight mechanism according to claim 2, wherein the at least one spring is configured such that a spring force generated by the at least one spring is zero when the counterweight is at a mid-position of the linear reciprocation.

8. The counterweight mechanism according to claim 1, wherein the counterweight is configured to linearly reciprocate along a direction opposite to a direction of motion of the linearly reciprocating mechanism.

9. The counterweight mechanism according to claim 1, wherein the counterweight is configured to reciprocate linearly along a direction perpendicular to a direction of motion of the linearly reciprocating mechanism.

10. The counterweight mechanism according to claim 2, wherein the at least one spring has one spring with a first end connected to the counterweight and a second end fixed at the frame.

11. The counterweight mechanism according to claim 2, wherein the at least one spring has two compression springs, one of the two compression springs being positioned between one end of the counterweight and the frame, and another of the two compression springs being positioned between another end of the counterweight and the frame.

12. The counterweight mechanism according to claim 11, wherein the two compression springs are configured such that only one end of each compression spring is connectable with the frame when another end of each compression spring is not connected to the counterweight.

13. The counterweight mechanism according to claim 1, further comprising:
a frame; and
a rotation shaft rotatably supported on the frame;
wherein the driving element includes an eccentric cam mounted onto a rotation shaft and configured to rotate with the rotation shaft.

14. The counterweight mechanism according to claim 13, wherein the guiding element includes a guiding portion fixed at the frame.

15. The counterweight mechanism according to claim 13, wherein:
the counterweight includes two parallel surfaces and two curved surfaces that define an elongated hole; and
the eccentric cam is mounted in the elongated hole such that an outer edge of the eccentric cam only contacts the two parallel surfaces of the elongated hole.

16. The counterweight mechanism according to claim 1, wherein:
the driving element comprises a driving rod configured to linearly reciprocate; and
the counterweight is mounted on the driving rod.

17. The counterweight mechanism according to claim 16, wherein:
the counterweight defines a through hole;
the guiding element includes a guiding rod passing through the through hole.

18. The counterweight mechanism according to claim 1, wherein the linearly reciprocating mechanism is a linearly reciprocating mechanism of a power tool.

19. The counterweight mechanism according to claim 18, wherein the power tool is a reciprocating saw or an electric hammer.

20. A power tool comprising:
a linearly reciprocating mechanism that includes:
a counterweight configured to balance an inertial force of the linearly reciprocating mechanism;
a driving element configured to drive the counterweight to linearly reciprocate;
a guiding element configured to guide the linear reciprocation of the counterweight; and
an auxiliary driving mechanism configured to auxiliarily drive the counterweight to linearly reciprocate, the auxiliary drive being further configured to exert a force on the counterweight in an alternatingly changing direction of the linear reciprocation of the counterweight to promote the linear reciprocation of the counterweight.
